(19) United States
(12) Patent Application Publication
(10) Pub. No.: US 2005/0141742 A1
(43) Pub. Date: Jun. 30, 2005

(54) Induction coil for a hearing aid

(76) Inventor: Thomas Kasztelan, Singapore (SG)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/001,606

(22) Filed: Dec. 1, 2004

(30) Foreign Application Priority Data
Dec. 1, 2003 (DE) 10356094.7

(51) Int. Cl. H04R 25/00

(52) U.S. Cl. 381/331; 381/312

(57) ABSTRACT

The aim is to reduce the costs of producing hearing aids whose induction coils are dumbbell shaped. To achieve this it is proposed mounting the core extensions (3) onto the ends of the core (1). Mu-metal disks or, as the case may be, mu-metal disks rings (3, 4) are preferably attached to the ends of the core (1). This will ensure production at an economical price; the induction coil will furthermore have high magnetic lateral sensitivity, which is advantageous during telephoning.

### CROSS REFERENCE TO RELATED APPLICATIONS

This application claims priority to the German application No. 10356094.7, filed Dec. 1, 2003 and which is incorporated by reference herein in its entirety.

### FIELD OF INVENTION

The present invention relates to an induction coil or, as the case may be, a telephone coil for a hearing aid, which coil has a cylindrical core and at least one core extension enlarging said core in a radial direction at one of its ends. The present invention further relates to a corresponding method for producing an induction coil of said type for hearing aids.

### BACKGROUND OF INVENTION

Induction coils are employed in hearing aids for the purpose of receiving magnetic signals. Typical areas of application in which the properties of induction coils can be exploited include, alongside telephony, catering for the hard of hearing in schools, cinemas, churches, and the like.

The induction coils currently used in hearing aids are typically 9 mm long and 1.4 to 1.9 mm deep. Their relatively long length gives rise to effects of coupling with, say, the hearing aid receiver or the battery contacts. Said long length furthermore allows only modest scope for locating the induction coil or moving it in the hearing aid.

### SUMMARY OF INVENTION

To avoid said coupling effects, the induction coil is as a rule located in the hearing aid as far away as possible from the receiver. As said coil's length often precludes achieving an adequate distance between itself and the receiver, in such cases a mu-metal sheet is inserted between said receiver and said coil. The mu-metal sheet indeed reduces the coupling effects, but it also lowers the induction coil's sensitivity.

The above-mentioned induction coil is known from specification DE 81 05 651 U1, where a core is used to whose lateral ends are applied widenings limiting the winding subsequently to be applied to said coil. Said widenings can be produced from the material, such as mu-metal, for instance, of which the coil core itself is made. Plastic may, however, also be used for said widenings or, as the case may be, lateral ends of the coil. The widenings at the ends of the coil body have the form of attached disks arranged to be concentric with the core. They thus delimit an available winding space.

A further induction coil for use as an electromagnetic induction transformer in electric hearing aids is known from specification DE 43 26 358. Said induction coil's coil body consists in this case of a punched part. Attached to said coil body's free end surfaces are formed parts having means for accommodating insulating parts. Said insulating parts have electrically conducting connection elements for contacting the coil winding.

An object of the present invention is hence to reduce the costs of producing induction coils for hearing aids.

Said object is achieved by the claims. Said core having the core extension is consequently of two-part design.

The induction coil can be shortened overall by the radial core extension at the end of the core. This is because the induction coil's inductance increases owing to the ferromagnetic core extension and the induction coil's antenna effect is thereby increased.

Shortening of the induction coil allows it to be better located in the hearing aid. The places at which it can be located include one at which less coupling effect can be expected. This in turn makes it possible to dispense with a mu-metal screening sheet between the receiver and induction coil in devices having a lower output power, which is to say whose receivers produce weaker leakage fields.

Shortening of the induction coil furthermore offers the advantage of needing to provide less space in the hearing aid for the induction coil. This in particular allows the hearing aid to be of smaller overall design, a factor to be regarded as a principal objective of hearing aid manufacturers.

The radial core extension in the end area of the induction coil core additionally results in improved magnetic lateral sensitivity. This is because the magnetic field lines at the end of the core are also guided outward in a radial direction by the ferromagnetic material of the core extension. This increased lateral sensitivity has advantages during telephoning because the induction coils in the hearing aid are as a rule arranged vertically and hence have their maximum sensitivity in the vertical direction. Sensitivity in the lateral direction toward a telephone receiver held to the ear is correspondingly low in the case of the induction coils having cylindrical cores of single-piece design. The directional characteristic is, however, weakened by the core extension so that changes in the position of the induction coil or, as the case may be, in the head of the person who is hard of hearing are less critical. Cross sensitivity can be improved specifically for, for instance, telephoning by means of a non-symmetrical core extension.

The core extension can be mounted onto one end of the core, which is to say it is embodied as being of two-part design therewith. This enables a highly economical solution to be realized compared to a dumbbell coil because the core of the known dumbbell coil is turned from one piece.

The core extension consists in a preferred embodiment of a ferromagnetic ring or ferromagnetic disk. This makes said extension easy to produce and mount. The ring or, as the case may be, disk moreover ensures better magnetic cross sensitivity or, as the case may be, lateral sensitivity in all radial directions referred to the induction coil core.

The core extension is preferably pasted, plugged, or pressed onto one end of the core. This enables economical assembly to be achieved.

The core extension can moreover be made of a mu-metal. This metal's permeability can advantageously be adjusted to the requirements accordingly.

It is especially preferred for a core extension to be located at each end of the core. The winding on the core will automatically also be secured in position thereby, obviating the need to attach special securing pieces such as, for example, plastic lamellas or, as the case may be, plastic rings, to the core.

### BRIEF DESCRIPTION OF THE DRAWINGS

The present invention is now explained in more detail with the aid of the attached drawings, of which:

FIG. 1 is a perspective view of an induction coil according to the invention;

FIG. 2 is a view of a single disk of the induction coil shown in FIG. 1;

FIG. 3 is a plan view of an induction coil according to the prior art having a directional characteristic; and

FIG. 4 is a plan view of an induction coil according to the invention having a directional characteristic.

### DETAILED DESCRIPTION OF INVENTION

The exemplary embodiment described in more detail below is a preferred embodiment of the present invention.

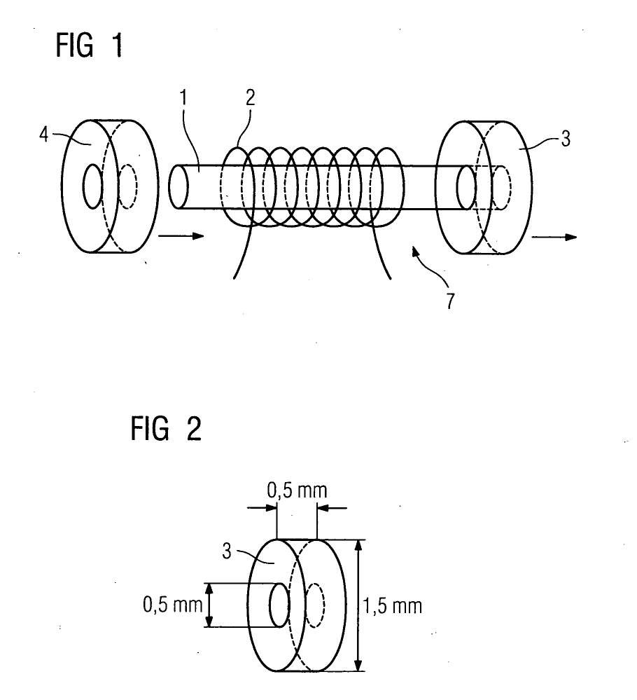

An induction coil according to the invention consists of a core 1 onto which is wound a winding 2. Attached to both ends of the core 1 are mu-metal disks or, as the case may be, mu-metal rings 3 and 4. Said mu-metal rings 3 and 4 are mounted by being pasted or, as the case may be, pressed onto the cylindrical core 1, as is indicated in FIG. 1 by the arrows.

A mu-metal ring 3 typically has the dimensions shown in FIG. 2. It accordingly has an outside diameter of approximately 1.5 mm and a thickness of approximately 0.5 mm. In the example chosen it further has a drilled hole having an inside diameter of 0.5 mm.

Corresponding mu-metal disks can also be pasted onto the end faces of the core as an alternative to the mu-metal rings 3 and 4 shown in FIGS. 1 and 2.

Both the mu-metal disks and the mu-metal rings 3 and 4 cause the core or, as the case may be, induction coil to have a dumbbell shape. The winding 2 on the core 1 is not only secured in position thereby; the magnetic field lines are also redirected at the end of the core 1 in a radial direction. The mu-metal disks or, as the case may be, mu-metal rings 3, 4 furthermore increase the end-face area of the induction coil, resulting in a collector effect on the part of the disks or, as the case may be, rings, which is to say on the par t of the core extensions.

The mu-metal collector disks or, as the case may be, mu-metal collector rings increase the sensitivity of the induction coils so that said coils can be shortened. The effects can be better demonstrated with the aid of the following exemplary numerical figures: If the coil is shortened from 9 mm to 7.5 mm, its sensitivity will be reduced by, on average, 1 to 2 dB. This reduction in sensitivity can be compensated by placing mu-metal collector disks or, as the case may be, mu-metal collector rings having the dimensions shown in FIG. 2 onto the ends of the induction coil's core. This shortening produces the cited advantages of being able to better locate the induction coil and reduce the size of the hearing aid.

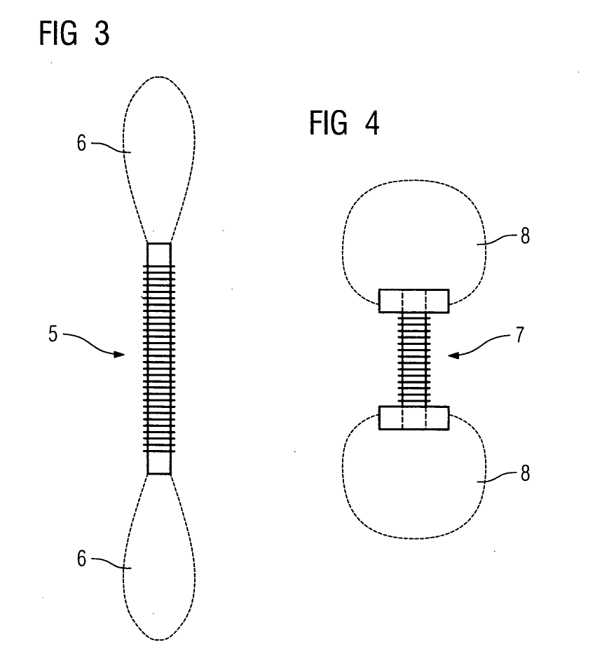

FIG. 3 shows a customary induction coil according to the prior art. It has a simple linear structure and a relatively large directional characteristic, as indicated by the lobes 6. Said directional characteristic is due primarily to the magnetic field lines' entering and exiting almost exclusively at the small end-face area of the core of the induction coil 5.

In contrast to this, FIG. 4 shows a dumbbell-shaped induction coil 7 according to the invention. The directional characteristic of said induction coil 7 is reduced by the mu-metal disks or, as the case may be, mu-metal rings at its two ends. Although the induction coil's maximum sensitivity is still in the direction of the coil's longitudinal axis, lateral sensitivity is significantly increased, which is indicated by the more rounded lobes 8. Said increased lateral sensitivity is positively apparent especially during telephoning.

1-8. (canceled)

9. An induction coil for a hearing aid, comprising:
a cylindrical core; and
a ferromagnetic core extension part enlarging said core in a radial direction relative to the cylindrical core, wherein the core extension part is mounted onto a core end of the cylindrical core.

10. The induction coil according to claim 9, wherein the core extension part is a ferromagnetic ring or a ferromagnetic disk.

11. The induction coil according to claim 9, wherein the core extension part is mounted onto the core end by applying one technique chosen from the group consisting of gluing, plugging and pressing.

12. The induction coil according to claim 9, wherein the core extension part consists of a μ-metal.

13. The induction coil according to claim 9, wherein each end of the cylindrical core includes a core extension part mounted to the respective core end.

14. A method of manufacturing an induction coil for a hearing aid, comprising:
providing a cylindrical core;
equipping the cylindrical core with a coil winding; and
mounting a ferromagnetic core extension part mounted onto a core end of the cylindrical core, wherein the core extension part enlarges the cylindrical core in a radial direction relative to the cylindrical core.

15. The method according to claim 14, wherein the core extension part is mounted onto the core end by applying one technique chosen from the group consisting of gluing, plugging and pressing.

16. The method according to claim 14, wherein each end of the cylindrical core includes a core extension part mounted to the respective core end.
